(19) United States
(12) Patent Application Publication
(10) Pub. No.: US 2023/0225319 A1
(43) Pub. Date: Jul. 20, 2023

(54) Antimicrobial Spray Composition

(71) Applicant: Kraton Polymers LLC, Houston, TX (US)

(72) Inventors: Bert Krutzer, Almere (NL); James D Smith, Houston, TX (US); Roger Tocchetto, Houston, TX (US); Richard Blackwell, Houston, TX (US)

(73) Assignee: Kraton Polymers LLC, Houston, TX (US)

(21) Appl. No.: 17/995,998

(22) PCT Filed: Apr. 19, 2021
(86) PCT No.: PCT/US2021/070413

§ 371 Date: Oct. 12, 2022

Related U.S. Application Data
(60) Provisional application No. 63/011,576, filed on Apr. 17, 2020.
(60) Provisional application No. 63/019,634, filed on May 4, 2020.
(60) Provisional application No. 63/200,309, filed on Mar. 1, 2021.

(51) Int. Cl. A01N 41/04; A01P 1/00; A01N 25/06; C09D 5/14; A01N 25/24; C09D 153/02

(52) U.S. Cl. CPC A01N 41/04; A01P 1/00; A01N 25/06; C09D 5/14; A01N 25/24; C09D 153/025

(57) ABSTRACT

An antimicrobial spray composition is disclosed, forming a protective film on surfaces when dried. The protective film provides antimicrobial protection by killing at least 95% of microorganisms in <30 minutes of exposure. The spray composition comprises a sulfonated polymer selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof. The sulfonated polymer has a degree of sulfonation of at least 10%

### TECHNICAL FIELD

The disclosure relates to an antimicrobial spray composition for protecting, coating, or covering surfaces, for extended antimicrobial effects killing microorganisms upon contact with the surfaces.

### BACKGROUND

Microorganisms are inherently present in the environment. Some microorganisms are beneficial to humans, and others are harmful as diseases spreading microbes, e.g., viruses, bacteria. With the spread of contagious diseases, it becomes necessary to protect people and prevent the people from coming into contact with the diseases spreading microbes.

In the prior art, the disinfection of surfaces is carried out either with traditional methods like liquid solutions such as sodium hypochlorite (bleach/chlorine) and alcohol at 70-90%, or ultraviolet (UV) radiation which can destroy the DNA of the virus. However, the treatment is short-term.

There is a need for a longer-term solution, for the protection of surfaces such as clothing, fabrics, carpet, furniture, linens, luggages, tents, upholstery, or basically high-contact surfaces, etc., in a spray form. After the composition is sprayed on a surface, it forms a film or a coating staying on the surface on for at least 24 hrs., preferably at least 1 month, and more preferably at least 2 months, providing extended antimicrobial protection.

### SUMMARY

In one aspect, an antimicrobial spray composition is disclosed. The spray composition comprises: a carrier fluid selected from water, solvents, liquid polymers, and combinations thereof; a binder; and a sulfonated polymer. The sulfonated polymer is selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof. The spray composition, when applied onto a substrate for a thickness of at least >1 μm, subsequently dries to form a film for killing at least 90% microbes within 120 minutes of contact with the film.

In some aspects, the antimicrobial spray composition is used to disinfect hard and soft surfaces.

In some aspects, the disclosure relates to a method to sterilize and prevent transmission of microbes from a surface prone to exposure to microbes. The method comprises forming a protective self-sterilizing layer on the surface, by spraying on the surface a protective composition. The protective composition comprises: a carrier fluid selected from water, solvents, liquid polymers, and combinations thereof; optionally a binder; and a sulfonated polymer being selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof; the sulfonated polymer has a degree of sulfonation of at least 10%. The protective composition subsequently dries on the surface to form a protective self-sterilizing layer, having a thickness of at least >1 μm for killing at least 90% microbes within 120 minutes of contact with the self-sterilizing layer.

### DESCRIPTION

The following terms used in the specification have the following meanings:

“Microorganisms” or “microbes” refer to organisms with microscopic size including bacteria, molds, mildews, algae, archaea, fungi (yeasts and molds), algae, protozoa, and viruses including coronavirus.

“Antimicrobial” refers to the ability of any composition contemplated by the disclosure to inhibit the growth of or to kill microorganisms such as without limitation bacteria, fungi, mildew, mold, and algae.

“Substrate” refers to a layer under something else to provide support, having at least one surface available to deposit or coat a material of the choice.

“Anti-fog” refers to the prevention or inhibition of build-up of condensation on a surface, e.g., a lens or a window, or a glass door, with an anti-fog coating. Anti-fog property can be expressed by T_{fog}, which is the time in minutes it takes to form a fog on a surface, e.g., exposing a layer (surface) to steam from boiling water at a 20 centimeter distance from the water's surface in an environment of 50% RH (relative humidity) and 22° C. If a surface has a T_{fog} of at 30 minutes, it means that no fog is formed on a surface of said coating within about 30 minutes under the testing conditions described.

“Effective amount” refers to an amount sufficient to alter, destroy, inactivate, neutralize and/or inhibit growth of microorganisms, e.g., an amount sufficient to sterilize and kill microorganisms in contact with the sulfonated polymeric layer applied to a substrate.

“Ion Exchange Capacity” or IEC refers to the total active sites or functional groups responsible for ion exchange in a polymer. Generally, a conventional acid-base titration method is used to determine the IEC, see for example International Journal of Hydrogen Energy, Volume 39, Issue 10, Mar. 26, 2014, Pages 5054-5062, “Determination of the ion exchange capacity of anion-selective membrane.” IEC is the inverse of “equivalent weight” or EW, which the weight of the polymer required to provide 1 mole of exchangeable protons.

“Surface pH” refers to the pH on the contact surface of the bio-secure material, that results from surface bound moieties e.g., the coating layer. The surface pH can be measured with commercial surface pH measuring instruments, e.g., SenTix™ Sur-electrode from WTW Scientific-Technical Institute GmbH, Weilheim, Germany.

“Dispersed or dispersion, or emulsion” refers to a two-phase system wherein one phase comprises finely divided particles distributed throughout a second phase, which is a bulk substance. The particles are the disperse or internal phase, and the bulk substance the continuous or external phase. The continuous phase can be water, an aqueous mixture, or an organic mixture. By “dispersion,” it is also meant that not necessarily all of the polymer needs to be water-insoluble.

The disclosure relates to an antimicrobial composition that can be sprayed onto surfaces, e.g., fabrics, carpet, chairs, linens, luggage, tents, upholstery, etc. The antimicrobial composition comprises, consists essentially of, or consists of a sufficient amount of sulfonated polymer, a carrier fluid, and optional binder, such that when the composition is sprayed on a surface, it forms a protective layer or film on the surface killing least 95% microorganisms that come into contact with the surfaces. The protective layer remains effective for a long period of time, for at least 4 hours, or at least 48 hours, at least a month, or 2 months.

Self-sterilizing Material—Sulfonated Polymer: Sulfonated polymer refers to polymers having a sulfonate group, e.g., —SO₃, either in the acid form (e.g., —SO₃H, sulfonic acid) or a salt form (e.g., —SO₃Na). The term “sulfonated polymer” also covers sulfonate containing polymers, e.g., polystyrene sulfonate.

The sulfonated polymer is selected from the group of perfluorosulfonic acid polymers (e.g., sulfonated tetrafluoroethylene), sulfonated polyolefins, sulfonated polyimides, sulfonated polyamides, sulfonated polyester, polystyrene sulfonates, sulfonated block copolymers, sulfonated polyolefins, sulfonated polysulfones such as polyether sulfone, sulfonated polyketones such as polyether ether ketone, sulfonated polyphenylene ethers, and mixtures thereof.

The sulfonated polymer is characterized as being sufficiently or selectively sulfonated to contain from 10-100 mol % sulfonic acid or sulfonate salt functional groups based on the number of monomer units or the block to be sulfonated (“degree of sulfonation”), to kill at least 95% of microbes within 120 minutes of coming into contact with the coating material. In embodiments, the sulfonated polymer has a degree of sulfonation of >25 mol %, or >50 mol %, or <95 mol %, or 25-70 mol %. Degree of sulfonation can be calculated by NMR or ion exchange capacity (IEC).

In embodiments, the sulfonated polymer is a sulfonated tetrafluoroethylene, having a polytetrafluoroethylene (PTFE) backbone; (2) side chains of vinyl ethers (e.g., —O—CF₂—CF—O—CF₂—CF₂—) which terminate in sulfonic acid groups in a cluster region.

In embodiments, the sulfonated polymer is a polystyrene sulfonate, examples include potassium polystyrene sulfonate, sodium polystyrene sulfonate, a co-polymer of sodium polystyrene sulfonate and potassium polystyrene sulfonate (e.g., a polystyrene sulfonate copolymer), having a molecular weight of 20,000 to 1,000,000 Daltons, or >25,000 Daltons, or >40,000 Dalton, or >50,000, or >75,000, or >100,000 Daltons, or >400,000 Daltons, or <200,000, or <800,000 Daltons, or up to 1,500,000 Daltons. The polystyrene sulfonate polymers can either be crosslinked or uncrosslinked. In embodiments, the polystyrene sulfonate polymers are uncrosslinked and water soluble.

In embodiments, the sulfonated polymer is a polysulfone, selected from the group of aromatic polysulfones, polyphenylenesulfones, aromatic polyether sulfones, dichlorodiphenoxy sulfones, sulfonated substituted polysulfone polymers, and mixtures thereof. In embodiments, the sulfonated polymer is a sulfonated polyethersulfone copolymer, which can be made with reactants including sulfonate salts such as hydroquinone 2-potassium sulfonate (HPS) with other monomers, e.g., bisphenol A and 4-fluorophenyl sulfone. The degree of sulfonation in the polymer can be controlled with the amount of HPS unit in the polymer backbone.

In embodiments, the sulfonated polymer is a sulfonated polyether ketone. In embodiments, the sulfonated polymer is a sulfonated polyether ketone ketone (SPEKK), obtained by sulfonating a polyether ketone ketone (PEKK). The polyether ketone ketone can be manufactured using diphenyl ether and a benzene dicarbonic acid derivative. The sulfonated PEKK can be available as an alcohol and/or water-soluble product, e.g., for subsequent use to coat the face mask or in spray applications.

In embodiments, the sulfonated polymer is a sulfonated poly(arylene ether) copolymer containing pendant sulfonic acid groups. In embodiments, the sulfonated polymer is a sulfonated poly(2,6-dimethyl-1,4-phenylene oxide), commonly referred to as sulfonated polyphenylene oxide. In embodiments, the sulfonated polymer is a sulfonated poly(4-phenoxybenzoyl-1,4-phenylene) (S-PPBP). In embodiments, the sulfonated polymer is a sulfonated polyphenylene having 2 to 6 pendant sulfonic acid groups per polymer repeat, and characterized as having 0.5 meq (SO₃H)/g of polymer to 5.0 meq (SO₃H)/g polymer, or at least 6 meq/g (SO₃H)/g polymer.

In embodiments, the sulfonated polymer is a sulfonated polyamide, e.g. aliphatic polyamides such nylon-6 and nylon-6,6, partially aromatic polyamides and polyarylamides such as poly(phenyldiamidoterephthalate), provided with sulfonate groups chemically bonded as amine pendant groups to nitrogen atoms in the polymer backbone. The sulfonated polyamide can have a sulfonation level of 20 to up to 100% of the amide group, with the sulfonation throughout the bulk of the polyamide. In embodiments, the sulfonation is limited to a high density of sulfonate groups at the surface, e.g., >10%, >20%, >30%, or >40%, or up to 100% of the sulfonated amide group at the surface (within 50 nm of the surface).

In embodiments, the sulfonated polymer is a sulfonated polyolefin, containing at least 0.1 meq, or >2 meq, or >3 meq, or >5 meq, or 0.1 to 6 meq of sulfonic acid per gram of polyolefin. In embodiments, the sulfonated polymer is a sulfonated polyethylene. The sulfonated polyolefin can be formed by chlorosulfonation of a solid polyolefin obtained by polymerization of an olefin or a mixture of olefins selected from a group consisting of ethylene, propylene, butene-1,4-methylpentene-1, isobutylene, and styrene. The sulfonyl chloride groups can then be hydrolyzed, for example, in an aqueous base such as potassium hydroxide or in a water dimethylsulfoxide (DMF) mixture to form sulfonic acid groups. In embodiment, the sulfonated polyolefin is formed by submerging or passing polyolefin object in any form of powder, fiber, yarn, woven fabric, a film, a preform, etc., through a liquid containing sulfur trioxide (SO₃), a sulfur trioxide precursor (e.g., chlorosulfonic acid, HSO₃Cl), sulfur dioxide (SO₂), or a mixture thereof. In other embodiments, the polyolefin object is brought into contact with a sulfonating gas, e.g., SO₂ or SO₃, or gaseous reactive precursor, or a sulfonation additive that evolves a gas SOX at elevated temperature.

The polyolefin precursor to be sulfonated can be, for example, a poly-a-olefin, such as polyethylene, polypropylene, polybutylene, polyisobutylene, ethylene propylene rubber, or a chlorinated polyolefin (e.g., polyvinylchloride, or PVC), or a polydiene, such as polybutadiene (e.g., poly-1,3-butadiene or poly-1,2-butadiene), polyisoprene, dicyclopentadiene, ethylidene norbornene, or vinyl norbornene, or a homogeneous or heterogeneous composite thereof, or a copolymer thereof (e.g., EPDM rubber, i.e., ethylene propylene diene monomer). In embodiments, the polyolefin is selected from low density polyethylene (LDPE), linear low density polyethylene (LLDPE), very low density polyethylene (VLDPE), high density polyethylene (HDPE), medium density polyethylene (MDPE), high molecular weight polyethylene (HMWPE), and ultra-high molecular weight polyethylene (UHMWPE).

In embodiments, the sulfonated polymer is a sulfonated polyimide, e.g., aromatic polyimides in both thermoplastic and thermosetting forms, having excellent chemical stability and high modulus properties. Sulfonated polyimide can be prepared by condensation polymerization of dianhydrides with diamines, wherein one of the monomeric units contains sulfonic acid, sulfonic acid salt, or sulfonic ester group. The polymer can also be prepared by direct sulfonation of aromatic polyimide precursors, using sulfonation agents such as chlorosulfonic acid, sulfur trioxide and sulfur trioxide complexes. In embodiments, the concentration of sulfonic acid groups in the sulfonated polyimide as measured by ion exchange capacity, IEC, varying from 0.1 meq/g to above 3 meq/g, or at least 6 meq/g.

In embodiments, the sulfonated polymer is a sulfonated polyester, formed by directly sulfonating a polyester resin in any form, e.g., fiber, yarn, woven fabric, film, sheet, and the like, with a sulfuric anhydride-containing gas containing sulfuric anhydride, for a concentration of the sulfone group on the surface of the polyester ranging from 0.1 meq/g to above 3 meq/g, e.g., up to 5 meq/g, or at least 6 meq/g.

In embodiments, the sulfonated polymer is a selectively sulfonated negative-charged anionic block copolymer. The term “selectively sulfonated” definition to include sulfonic acid as well as neutralized sulfonate derivatives. The sulfonate group can be in the form of metal salt, ammonium salt or amine salt.

Depending on the applications and the desired properties, the sulfonated polymer can be modified (or funcationalized). In embodiments, the sulfonated polymer is neutralized with any of various metal counterions, including alkali, alkaline earth, and transition metals, with at least 10% of the sulfonic acid groups being neutralized. In embodiments, the sulfonated polymer is neutralized with inorganic or organic cationic salts, e.g, those based on ammonium, phosphonium, pyridinium, sulfonium and the like. Salts can be monomeric, oligomeric, or polymeric. In embodiments, the sulfonated polymer is neutralized with various primary, secondary, or tertiary amine-containing molecules, with >10% of the sulfonic acid or sulfonate functional groups being neutralized.

In embodiments, the sulfonic acid or sulfonate functional group is modified by reaction with an effective amount of polyoxyalkyleneamine having molecular weights from 140 to 10,000. Amine-containing neutralizing agents can be mono-functional or multi-functional; monomeric, oligomeric, or polymeric. In alternative embodiments, the sulfonated polymer is modified with alternative anionic functionalities, such as phosphonic acid or acrylic and alkyl acrylic acids.

In embodiments, amine containing polymers are used for the modification of the sulfonated polymers, forming members of a class of materials termed coaservates. In examples, the neutralizing agent is a polymeric amine, e.g., polymers containing benzylamine functionality. Examples include homopolymers and copolymers of 4-dimethylaminostyrene which has been described in U.S. Pat. No. 9,849,450, incorporated herein by reference. In embodiments, the neutralizing agents are selected from polymers containing vinylbenzylamine functionality, e.g., polymers synthesized from poly-p-methylstyrene containing block copolymers via a bromination-amination strategy, or by direct anionic polymerization of amine containing styrenic monomers. Examples of amine functionalities for functionalization include but are not limited to p-vinylbenzyldimethylamine (BDMA), p-vinylbenzylpyrrolidine (VBPyr), p-vinylbenzyl-bis(2-methoxyethyl)amine (VBDEM), p-vinylbenzylpiperazine (VBMPip), and p-vinylbenzyldiphenylamine (VBDPA). In embodiments, corresponding phosphorus containing polymers can also be used for the functionalization of the sulfonated polymers.

In embodiments, the monomer or the block containing amine functionality or phosphine functionality can be neutralized with acids or proton donors, creating quaternary ammonium or phosphonium salts. In other embodiments, the sulfonated polymer containing tertiary amine is reacted with alkylhalides to form functional groups, e.g., quaternized salts. In some embodiments, the sulfonated polymer can contain both cationic and anionic functionality to form so-called zwitterionic polymers.

In some embodiments, the sulfonated polymer is a selectively sulfonated negative-charged anionic block copolymer, which “selectively sulfonated” definition to include sulfonic acid as well as neutralized sulfonate derivatives. The sulfonate group can be in the form of metal salt, ammonium salt or amine salt. In embodiments, the sulfonated block polymer has a general configuration A-B-A, (A-B)ₙ(A), (A-B-A)ₙ, (A-B-A)ₙX, (A-B)ₙX, A-D-B, A-B-D, A-D-B-D-A, A-B-D-B-A, (A-D-B)ₙA, (A-B-D)ₙA (A-D-B)ₙX, (A-B-D)ₙX or mixtures thereof; where n is an integer from 0 to 30, or 2 to 20 in embodiments; and X is a coupling agent residue. Each A and D block is a polymer block resistant to sulfonation. Each B block is susceptible to sulfonation. For configurations with multiple A, B or D blocks, the plurality of A blocks, B blocks, or D blocks can be the same or different.

In embodiments, the A blocks are one or more segments selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof. If the A segments are polymers of 1,3-cyclodiene or conjugated dienes, the segments will be hydrogenated subsequent to polymerization of the block copolymer and before sulfonation of the block copolymer. The A blocks may also contain up to 15 mol % of the vinyl aromatic monomers such as those present in the B blocks.

In embodiments, the A block is selected from para-substituted styrene monomers selected from para-methyl styrene, para-ethyl styrene, para-n-propyl styrene, para-iso-propyl styrene, para-n-butyl styrene, para-sec-butyl styrene, para-iso-butylstyrene, para-t-butylstyrene, isomers of para-decylstyrene, isomers of para-dodecylstyrene and mixtures of the above monomers. Examples of para-substituted styrene monomers include para-t-butylstyrene and para-methylstyrene, with para-t-butylstyrene being most preferred. Monomers may be mixtures of monomers, depending on the particular source. In embodiments, the overall purity of the para-substituted styrene monomers be at least 90%-wt., or >95%-wt., or >98%-wt. of the para-substituted styrene monomer.

In embodiments, the block B comprises segments of one or more polymerized vinyl aromatic monomers selected from unsubstituted styrene monomer, ortho-substituted styrene monomers, meta-substituted styrene monomers, alpha-methylstyrene monomer, 1,1-diphenylethylene monomer, 1,2-diphenylethylene monomer, and mixtures thereof. In addition to the monomers and polymers noted, in embodiments the B blocks also comprises a hydrogenated copolymer of such monomer (s) with a conjugated diene selected from 1,3-butadiene, isoprene and mixtures thereof, having a vinyl content of between 20 and 80 mol percent. These copolymers with hydrogenated dienes can be any of random copolymers, tapered copolymers, block copolymers or controlled distribution copolymers. The block B is selectively sulfonated, containing from about 10 to about 100 mol % sulfonic acid or sulfonate salt functional groups based on the number of monomer units. In embodiments, the degree of sulfonation in the B block ranges from 10 to 95 mol %, or 15-80 mol %, or 20-70 mol %, or 25-60 mol %, or >20 mol %, or >50 mol %.

The D block comprises a hydrogenated polymer or copolymer of a conjugated diene selected from isoprene, 1,3-butadiene and mixtures thereof. In other examples, the D block is any of an acrylate, a silicone polymer, or a polymer of isobutylene with a number average molecular weight of >1000, or >2000, or >4000, or >6000.

The coupling agent X is selected from coupling agents known in the art, including polyalkenyl coupling agents, dihaloalkanes, silicon halides, siloxanes, multifunctional epoxides, silica compounds, esters of monohydric alcohols with carboxylic acids, (e.g. methylbenzoate and dimethyl adipate) and epoxidized oils.

The antimicrobial and mechanical properties of the sulfonated block copolymer can be varied and controlled by varying the amount of sulfonation, the degree of neutralization of the sulfonic acid groups to the sulfonated salts, as well as controlling the location of the sulfonated group(s) in the polymer. In embodiments and depending on the applications, e.g., one with the need for water dispersity/solubility, or at the other spectrum, one with the need for sufficient durability with constant wiping with water based cleaners, the sulfonated block copolymer can be selectively sulfonated for desired water dispersity properties or mechanical properties, e.g., having the sulfonic acid functional groups attached to the inner blocks or middle blocks, or in the outer blocks of a sulfonated block copolymer, as in U.S. Pat. No. 8,084,546, incorporated by reference. If the outer (hard) blocks are sulfonated, upon exposure to water, hydration of the hard domains may result in plasticization of those domains and softening, allowing dispersion or solubility.

The sulfonated copolymer in embodiments is as disclosed in Patent Publication Nos. U.S. Pat. Nos. 9,861,941, 8,263,713, 8,445,631, 8,012,539, 8,377,514, 8,377,515, 7,737,224, 8,383,735, 7,919,565, 8,003,733, 8,058,353, 7,981,970, 8,329,827, 8,084,546, 8,383,735, 10,202,494, and 10,228,168, the relevant portions are incorporated herein by reference.

In embodiments, the sulfonated block copolymer has a general configuration A-B-(B-A)₁₋₅, wherein each A is a non-elastomeric sulfonated monovinyl arene polymer block and each B is a substantially saturated elastomeric alpha-olefin polymer block, said block copolymer being sulfonated to an extent sufficient to provide at least 1% by weight of sulfur in the total polymer and up to one sulfonated constituent for each monovinyl arene unit. The sulfonated polymer can be used in the form of their acid, alkali metal salt, ammonium salt or amine salt.

In embodiments, the sulfonated block copolymer is a sulfonated polystyrene-polyisoprene-polystyrene, sulfonated in the center segment. In embodiments, the sulfonated block copolymer is a sulfonated t-butylstyrene/isoprene random copolymer with C═C sites in their backbone. In embodiments, the sulfonated polymer is a sulfonated SBR (styrene butadiene rubber) as disclosed in U.S. Pat. No. 6,110,616 incorporated by reference. In embodiments, the sulfonated polymer is a water dispersible BAB triblock, with B being a hydrophobic block such as alkyl or (if it is sulfonated, it becomes hydrophilic) poly(t-butyl styrene) and A being a hydrophilic block such as sulfonated poly(vinyl toluene) as disclosed in U.S. Pat. No. 4,505,827 incorporated by reference. In embodiments, the sulfonated block copolymer is a functionalized, selectively hydrogenated block copolymer having at least one alkenyl arene polymer block A and at least one substantially completely, hydrogenated conjugated diene polymer block B, with substantially all of the sulfonic functional groups grafted to alkenyl arene polymer block A (as disclosed in U.S. Pat. No. 5,516,831, incorporated by reference). In embodiments, the sulfonated polymer is a water-soluble polymer, a sulfonated diblock polymer of t-butyl styrene/styrene, or a sulfonated triblock polymer of t-butyl styrene-styrene-t-butyl styrene as disclosed in U.S. Pat. No. 4,492,785 incorporated by reference. In embodiments, the sulfonated block copolymer is a partially hydrogenated block copolymer.

In embodiments, the sulfonated polymer is a midblock-sulfonated triblock copolymer, or a midblock-sulfonated pentablock copolymer or, e.g., a poly(p-tert-butylstyrene-b-styrenesulfonate-b-p-tert-butylstyrene), or a poly[tert-butylstyrene-b-(ethylene-alt-propylene)-b-(styrenesulfonate)-b-(ethylene-alt-propylene)-b-tert-butylstyrene.

In embodiments, the sulfonated polymer contains >15 mol %, or >25 mol %, or >30 mol %, or >40 mol %, or >60 mol % sulfonic acid or sulfonate salt functional groups based on the number of monomer units in the polymer that are available or susceptible for sulfonation, e.g., the styrene monomers.

In embodiments, the sulfonated polymer has an ion exchange capacity of >0.5 meq/g, or >0.75 meq/g, or >1.0 meq/g, or >1.5 meq/g, or >2.0 meq/g, or >2.5 meq/g, or <5.0 meq/g.

Properties of Sulfonated Polymer: In embodiments, the sulfonated polymer is characterized as being sufficiently sulfonated to have an IEC of >0.5 meq/g, or 1.5-3.5 meq/g, or >1.25 meq/g, or >2.2 meq/g, or >2.5 meq/g, or >4.0 meq/g, or <4.0 meq/g.

In embodiments, the sulfonated polymer is characterized as having a surface pH of <3.0, or <2.5, or <2.25, or <2.0, or <1.80. It is believed that a sufficiently low pH surface level, as a result of the presence of sulfonic acid functional groups in the spray composition, for killing microorganisms that come in contact with the protected surface, including bacteria, viruses, algae, mold and fungi in the environment (e.g., air or water).

In embodiments, the sulfonated polymer works effectively in destroying/inactivating >90%, or >95, or >99%, or >99.5%, or >99.9% of microorganisms within <120 minutes of exposure, <60 minutes exposure, <30 minutes of exposure, or <5 minutes of exposure or contact with microorganisms, including but not limited to MRSA, vancomycin-resistant Enterococcus faecium, X-MulV, PI-3, SARS-CoV-2, carbapenem-resistant Acinetobacter baumannii, and influenza A virus. In embodiments with polymer(s) containing quaternary ammonium group, the material is effective in killing target microorganisms including Staphylococcus aureus, Escherichia coli, Staphylococcus albus, Escherichia coli, Rhizoctonia solani, and Fusarium oxysporum. The sulfonated polymer remains effective in killing microbes even after 4 hours, or after 12 hours, or at least 24 hours, or for at least 48 hours. In embodiments, the sulfonated polymer remains effective in killing microbes for at least 3 months, or for at least 6 months.

The sulfonated polymer contains from 10-100 mol % sulfonic acid or sulfonate salt functional groups based on the number of monomer units or blocks in the sulfonated polymer susceptible to sulfonation (i.e., can be sulfonated), for the coating material to kill at least 95% of microbes within 120 minutes of contact. In tests simulating cleaning of the surface of a sulfonated polymeric film, after 2400 cleaning or abrasion cycle, representing 200 days (at least 6 months) in use with 6 cleaning sessions per day (with 4 rubbing motions per session with alcohol and/or quaternary ammonium compounds cleaners), the sulfonated polymer still remains effective in killing microbes.

In embodiments, the sulfonated polymer is characterized as having anti-fogging properties, with a T_{fog} of >5 minutes , i.e., no fog is formed on a surface of substrates having sulfonated polymer coating within about 5 minutes. In embodiments, the T_{fog} is >15 minutes, or >30 minutes.

Depending on the sulfonated polymer used and the type of the liquid carrier, in embodiments, the amount of sulfonated polymer in the spray composition ranges from 0.05 to 10 wt. %, or 0.1-5 wt. %, or <5 wt. %, or <4 wt. %, or 0.25-2.5 wt. %, based on the total weight of the spray composition.

Liquid Carrier: The spray composition comprises a liquid carrier, e.g., any of aqueous, organic, or combinations thereof. The liquid carrier disperses and may solubilize, partially solubilize, or dissolve the other components of the spray composition.

In embodiments, the carrier is aqueous, e.g., water, although solvents that are miscible with water can be used as co-solvents. Examples of suitable co-solvents include ethers, esters, alcohols, glycols, aromatics, and the like. Specific examples include ethylene glycol or a derivative thereof, such as ethylene glycol monoethyl ether, ethylene glycol monobutyl ether, diethylene glycol monobutyl ether, or ethylene glycol monohexyl ether; propylene glycol or a derivative thereof, such as propylene glycol monomethyl ether, propylene glycol monoethyl ether, or propylene glycol monobutyl ether; or combinations thereof. In embodiments, the aqueous liquid carrier consists of, or consists essentially of water. In embodiments, the carrier is non-aqueous, e.g., an organic carrier. Examples include but not limited to aromatic materials such as benzene, xylene, toluene, low-boiling ethers, esters, alcohols, ketones such as methyl isobutyl ketone, methyl amyl ketone, naptha, and mixtures thereof. In embodiments, the carrier is an organic solvent selected from the group consisting of C1-6 alkanols, C1-6 diols, C1-6 alkyl ethers of alkylene glycols and polyalkylene glycols, and mixtures thereof.

The liquid carrier is present in an effective amount for creating a solution or emulsion when mixed with the other components, such as 20-80 wt. %, 30-75 wt. %, or >10 wt. %, or <99 wt. %, or <95 wt. %, or <90 wt. %, based on the total weight of the spray composition.

Binder: The spray composition also comprise a binder or a film forming component, for forming a water-insoluble film when the spray composition is applied to a surface. In embodiments, the binder is the component typically present in fabric coating spray compositions, or in glass treatment compositions, and the like, for forming a thin protective layer coating on the sprayed substrate.

In embodiments, the film forming component is a polyurethane obtained by the reaction of an isocyanate-functional polyurethane prepolymer with an isocyanate-reactive component.

In embodiments, the film forming component is a fluorochemical urethane compound, derived from the reaction of a polyfunctional isocyanate compound; a fluorochemical monofunctional compound, and optionally a hydrophilic polyoxyalkylene compound and/or a silane compound, as disclosed in WO20040701105A, incorporated herein by reference. In embodiments, the binder is a water soluble or water dispersible fluorochemical silane as disclosed in U.S. Pat. No. 6,977,307, incorporated herein by reference.

In embodiments, the film forming component is a fluorochemical urethane, formed as the reaction product of (a) one or more polyfunctional isocyanate compounds; (b) one or more hydrophilic polyoxyalkylene compounds; and (c) one or more fluorochemical monofunctional compounds; and (d) optionally, one or more silane compounds; and/or (e) optionally, an isocyanate blocking group such as an oxime, as disclosed in US 2007/0014927, incorporated herein by reference.

In embodiments, the film forming component is a water dispersible flurochemical silane as disclosed in U.S. Pat. Nos. 5,980,992 and 6,977,307, incorporated herein by reference.

The amount of film forming component in the spray composition is sufficient for the composition to form a very thin layer, e.g., <1000 μm, or <100 μm, or >10 μm; or in embodiments, in amount of 0.1 to 10 wt. %, or 0.5 to 5 wt. %, or <7 wt. %, or >0.5 wt %, based on total weight of the spray composition. In embodiments, the binder (or film forming component) is optional.

Optional Propellant: If the composition is for use in a spray can, the spray composition may comprise a propellant, a hydrocarbon having carbon atoms, e.g., methane, ethane, n-propane, n-butane, isobutene, etc. In embodiments, the propellant further includes carbon dioxide, nitrogen, and compressed air. The content of the propellant, if used in a spray can, in embodiments range from 1-50 wt. %, or >5 wt. %, or <30 wt. %.

If the spray composition is for use with a propellant in a dispenser, the non-propellant components are mixed and loaded into the dispenser first. Thereafter, the liquefied gaseous propellant can be inserted before the dispenser is fitted with a nozzle.

Optional Additives: In embodiments, the spray composition comprises optional additives such as fragrances, dyes (colorant or pigment), wetting agents, and the like. In embodiments, the spray further comprises additives for decorative or safety effects, e.g., luminescent additives such as phosphorescent and fluorescence that would help or enable the sulfonated polymer layer to illuminate. In embodiments, the optional additives are optical brighteners additives that illuminate under a special UV or black light tracer, allowing for physical inspections to verify that intended surfaces are coated with a film or that the film has remained intact, offering the intended antimicrobial/self-disinfecting effects.

In embodiments, the antimicrobial liquid or film further comprises a color change pH indicator. A color change means a change in hue, from a light to a darker color or vice versa. A color indicator may indicate if a recharge, regeneration, or reactivation of the antimicrobial activity of the protective layer is recommended. The color indicator is incorporated in a sufficient amount so that a noticeable change in color hue is observed immediately when there is a change in the effectiveness of the sulfonated polymer in the protective film, e.g., when its surface pH is increased above 2.0 (different pathogens have different pH responses), the change is known right away. In embodiments, the amount of color indicator ranges from 0.1 to 20 wt. % of the amount of sulfonated polymer applied as a protective layer on the frequently-touched surface.

In embodiments, the spray composition further comprises an emulsifying agent, selected from any of an anionic, cationic nonionic, amphoteric, or zwitterionic surfactant.

In embodiments, the spray composition comprises optical additives including but not limited to UV stabilizers, e.g., UV absorbers, quenchers known in the art, elution additives, coalescing aids, wetting agents, surfactants, thickeners, rheology modifiers, defoamers, compatibilizers, plasticizers, tackifiers, cross-linkers, UV absorbers, and the like.

In embodiments, the optional additives include other antimicrobial components known in the art, e.g., the inclusion of a water-soluble quaternary ammonimum organosilane as disclosed in US Patent Publication No. US2002/0141959, incorporated herein by reference.

The optional additives may be included in amounts of >0.05 wt. %, or >0.1 wt. %, or <5 wt. %, or 0.5-10 wt. %, or 0.1-2 wt. %, based on the total weight of the spray composition.

Methods for Incorporating Sulfonated Polymers onto/into Spray Composition: The sulfonated polymer is added to the spray composition in a sufficient amount necessary to at least kill 95% microorganisms after application. It should be noted that in embodiments, the spray composition is applied for its anti-fog effect in addition to antimicrobial benefits. Depending on the application (e.g., anti-fog property and/or anti-microbial properties, etc.), the thickness of the spray coating (e.g., a very thin transparent for a glass surface, or a thick coating for highly touched surface, etc.), in embodiments, the amount of sulfonated polymer after drying ranges from up to 100% of the sprayed film, or 2 to 90 wt. % o, or >5 wt. %, or <80 wt. %, of 90 wt. %, or 10-90 wt. %, or 20-80 wt. %. In embodiments, the thickness of the sulfonated polymer (antimicrobial/protective layer) on the substrate (after the spray composition has dried) ranges from 12 to 25 microns.

In embodiments, the spray composition is prepared by combining the liquid carrier, the binder, the sulfonated polymer, and optional components individually or in combinations, sequentially or simultaneously, or combinations thereof. The step of combining may be performed by manual or automated processes, or combinations, by any of mixing, blending, stirring, and the like, and combinations thereof.

The sulfonated polymer is provided in the form of crumbs, films, membranes, fiber, or dispersion in water or solvent.

In embodiments, the sulfonated polymer for incorporating into the spray composition, can be first prepared by dissolving into an organic solvent or a non-aqueous dispersion prior to mixing with other spray composition components, e.g., liquid carried and the binder. The solvents can include one or more aprotic polar solvents including ethers, amides, esters, ketones, nitriles, tertiary amines, sulfates and sulfoxide. In embodiments, the sulfonated polymer is applied as a solution containing aliphatic hydrocarbons like cyclohexane, in aromatic hydrocarbons like toluene, in alcohols like methanol, ethanol, propanol, benzyl alcohol and the like, in various carbonyl solvents like methylethylketone, acetone, etc., or in a nitrogen containing solvents like N-methyl pyrolidone, N,N-dimethyl acetamide, pyridine, etc.

In embodiments, the sulfonated polymer is prepared as disclosed in U.S. Pat. No. 9,988,500 incorporated by reference, by first dissolving the polymer in an apolar solvent, then mixed with a co-solvent (e.g., MEK, 1-propanol, or THF). The mixture is emulsified in water to produce an emulsion. The solvent and optionally the co-solvent from the emulsion is mixed to produce an aqueous emulsion to mix with other components of the spray composition.

Spray Applications: Depending on the type of binder used, the carrier, the sulfonated polymer employed, the concentrations of the components, and ambient conditions (e.g., temperature and humidity) the spray composition effectively forms an antimicrobial layer or film on substrate surfaces in <6 hours, or <4 hours, or <2 hours, or >5 minutes, providing antimicrobial protection by killing at least 95%, or at least 99.%, or at least 99.5% of microorganisms in <30 minutes of exposure, or <5 minutes of exposure, with the antimicrobial protection lasting at least 30 days, or 60 days.

Surfaces herein refers to all hard and soft surfaces, including but not limited to tiles, floor materials, chrome, glass, vinyl products, plastics, wood, metals, metal alloys, laminates, etc.; building materials (e.g., doors, door knobs, walls, etc.), facilities (e.g., building, offices, etc.), fabrics (e.g., clothing, curtains, drapes, etc.); furniture (e.g., chairs, seats, trays, etc.); medical devices; laboratory equipment; appliances, etc.

The spray composition can be formulated into various suitable spray forms. For example, the spray composition may be packaged using a manual spray distributor, e.g., a trigger spray distributor or a pump-type spray distributor. Spray distributors evenly apply the present composition onto a relatively wide area of a surface to be disinfected and thus contribute to the antimicrobial property of the present composition. Such spray distributors are especially suitable for disinfection of perpendicular surfaces.

For home use, the spray composition can be employed or dispensed from pressurized can that is equipped with a nozzle so that an aerosol of the formulation can be readily sprayed onto a surface. The pressure within the dispenser or pressurized can is preferably in the range of 10 to 100 psi at ambient conditions.

In embodiments, the spray composition is used with a “fog machine” which aerosolizes the composition onto surfaces, e.g., as in a room, an airplane cabin, etc. periodically, e.g., every few days, every few weeks, every month, every other month, etc., including the ceilings, seats, trays, floors, rest areas, galleys, etc. The spray composition can also be applied by an automatic fog machine for periodic spraying of surfaces in a room, or used in a AI (artificial intelligence) robot spray machine for periodic spraying/providing antimicrobial protection for selective surfaces in a building or a room, e.g., certain walls, doorknobs, furniture, etc., in an operating room, a hospital, a medical facility, and the like. The composition can also be for home use, with periodic spraying of highly touched surfaces, door knobs, mailboxes, etc.

Example 1: Tests were conducted to evaluate antimicrobial efficacy & the long-lasting antiviral properties of sulfonated polymers, film samples of sulfonated penta block copolymer (SPBC) of the structure poly[tert-butylstyrene-b-(ethylene-alt-propylene)-b-(styrene-co-styrene-sulfonate)-b-(ethylene-alt-propylene)-tert-butylstyrene] with 52% sulfonation were cast out of 1:1 mixture of toluene and 1-propanol. The sulfonated polymer film samples were subjected to abrasion testing of 2200 cycles in the presence of 3 common disinfectants: 1) 70% ethanol, benzalkonium chloride, and quaternary ammonia], and exposure to SARS-CoV-2 virus suspension of concentration 10⁷ pfu/ml.

After 2 hours of contact, viable virus was recovered from each sample by washing twice with 500 μl of DMEM tissue culture media containing 10% serum, and measured by serial dilution plaque assay. Gibco Dulbecco's Modified Eagle Medium (DMEM) is a basal medium for supporting the growth of many different mammalian cells. The results demonstrate that, after abrasion testing representing approximately one year of cleaning (6 disinfectant wipes/day), surface pro Gibco Dulbecco's Modified Eagle Medium (DMEM) is a widely used basal medium for supporting the growth of many different mammalian cells.

Example 2: The example was conducted to evaluate the effectiveness in inhibiting Aspergillus niger black mold according to the AATCC Test Method 30-2004 Test III. Six different sulfonated block copolymer membrane samples comprising a poly[tert-butylstyrene-b-(ethylene-alt-propylene)-b-(styrenesulfonate)-b-(ethylene-alt-propylene)-b-tert-butylstyrene], at different levels of sulfonation from 26 to 52% were used for the tests. Aspergillus niger, ATCC #6275, was harvested into sterile distilled water containing glass beads. The flask was shaken to bring the spores into suspension. The suspension was used as the test inoculum. One (1.0) mL of the inoculum was even distributed over the surface of Mineral Salts Agar plates. The membrane samples were placed onto the inoculated agar surface. After placement, 0.2 mL of the inoculum was distributed over the surface of each disc. A viability plate of the spore suspension was prepared on Mineral Salts Agar with 3% glucose. A positive growth control was prepared using an untreated cotton duck fabric on Mineral Salts Agar and set up in the same manner as the test items. All samples were incubated at 28° C.±1° C. for 14 days.

The viability plate had acceptable fungal growth as expected confirming the viability of the inoculum. The sample with 26% sulfonation showed microscopic growth on 10% of the sample surface. The other 5 test samples showed no growth, or microscopic growth on 1% of the surface. The control sample showed macroscopic growth on 100% of the surface.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs the recitation of a genus of elements, materials or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. An antimicrobial spray composition comprising:
a carrier fluid selected from water, solvents, liquid polymers or waxes, and combinations thereof;
up to 10 wt. % of a binder;
0.1-5 wt. % of a sulfonated polymer selected from the group of the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof, the the sulfonated polymer has a degree of sulfonation of at least 10%;
wherein the spray composition, when applied onto a substrate, subsequently dries to form a sulfonated polymer layer having a thickness of at least >1 μm for killing at least 95% microbes within 30 minutes of contact with the film.

2. The antimicrobial spray composition of claim 1, wherein the sulfonated polymer has an ionic exchange capacity (IEC) of >0.5 meq/g.

3. The antimicrobial spray composition of claim 1, wherein the spray composition forms a sulfonated polymer layer having a thickness of at least >5 μm to kill >95% of microbes within 120 minutes of contact after six months of application onto the surfaces.

4. The antimicrobial spray composition of claim 1, wherein the sulfonated polymer is selectively sulfonated to contain from 10-100 mol % sulfonic acid or sulfonate salt functional groups based on the number of monomer units or blocks in the sulfonated polymer susceptible to sulfonation, for the coating material to kill at least 95% of microbes within 30 minutes of contact.

5. The antimicrobial spray composition of claim 1, wherein the sulfonated polymer is a selectively sulfonated negatively-charged block copolymer having a general configuration of: A-B-A, (A-B)n(A), (A-B-A)n, (A-B-A)nX, (A-B)nX, A-D-B, A-B-D, A-D-B-D-A, A-B-D-B-A, (A-D-B)nA, (A-B-D)nA (A-D-B)nX, (B-D-B)nX, (A-B-D)nX or mixtures thereof, wherein
n is an integer from 0 to 30,
X is a coupling agent residue,
each A and D block is a polymer block resistant to sulfonation,
each B block is susceptible to sulfonation,
the A block is selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof;
the B block is a vinyl aromatic monomer,
the D block is a hydrogenated polymer or copolymer of a conjugated diene selected from isoprene, 1,3-butadiene and mixtures thereof;
wherein the block B is selectively sulfonated to contain from 10-100 mol % sulfonic acid or sulfonate salt functional groups based on the number of monomer units for the antimicrobial layer to kill at least 99% of microbes within 30 minutes of contact.

6. The antimicrobial spray composition of claim 1, wherein the sulfonated polymer layer has a surface pH of <3.0.

7. The antimicrobial spray composition of claim 1, wherein the sulfonated polymer is neutralized with at least an inorganic or organic cationic salts.

8. The antimicrobial spray composition of claim 1, wherein the sulfonated polymer is neutralized with at least a salt selected from ammonium, phosphonium, pyridinium, and sulfonium salts.

9. The antimicrobial spray composition of claim 1, wherein the sulfonated polymer is water dispersible.

10. The antimicrobial spray composition of claim 1, wherein the sulfonated polymer is a selectively sulfonated negative-charged anionic block copolymer, having at least one alkenyl arene polymer block A and at least one substantially completely, hydrogenated conjugated diene polymer block B, with substantially all of the sulfonic functional groups grafted to alkenyl arene polymer block A for the block A to be a hydrophilic end-block.

11. (canceled)

12. The antimicrobial spray composition of claim 1, further comprising at least an additive selected from elution additives, coalescing aids, surfactants, wetting agents, thickeners, rheology modifiers, defoamers, surfactants, UV absorbers, and mixtures thereof.

13. The antimicrobial spray composition of claim 1, wherein the spray composition is applied onto the substrate by any of spraying, air spraying, airless spraying, electrostatic spraying, air-assisted airless spraying, hot spraying, rotation bell spraying, rotary atomizing, coating, brush coating, roll coating, dip coating, flow coating, curtain coating, barrel coating, electrocoating, dispersion coating, high-volume, low-pressure spray, and spraybrush.

14. The antimicrobial spray composition of claim 1, wherein the substrate is at least one selected from indoor and outdoor objects/structures, construction material, metal, metal pipe, masonry, wood, decking, docks, boat, roads, siding, porous or semi-porous materials including stone, brick, wall board, drywall, ceiling tiles, concrete, unglazed tile, stucco, grout, sprayed surfaces, roofing tiles, shingles, and sprayed or treated wood.

15. A method to sterilize and prevent transmission of microbes from a surface prone to exposure to microbes, the method comprises forming a protective self-sterilizing layer on the surface, by spraying on the surface a composition comprising:
a carrier fluid selected from water, solvents, liquid polymers, and combinations thereof;
optionally a binder;
a sulfonated polymer being selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof; the sulfonated polymer has a degree of sulfonation of at least 10%;
wherein the composition subsequently dries on the surface to form a protective self-sterilizing layer having a thickness of at least >1 μm for killing at least 90% microbes within 120 minutes of contact with the self-sterilizing layer.

16. The method of claim 15, wherein the sulfonated polymer has an ionic exchange capacity (IEC) of >0.5 meq/g.

17. The method of claim 15, wherein the spray composition forms a sulfonated polymer layer having a thickness of at least >5 μm to kill >95% of microbes within 120 minutes of contact after six months of application onto the surfaces.

18. The method of claim 15, wherein the sulfonated polymer is selectively sulfonated to contain from 10-100 mol % sulfonic acid or sulfonate salt functional groups based on the number of monomer units or blocks in the sulfonated polymer susceptible to sulfonation, for the coating material to kill at least 95% of microbes within 30 minutes of contact.

19. The method of claim 15, wherein the sulfonated polymer is a selectively sulfonated negatively-charged block copolymer having a general configuration of: A-B-A, (A-B)n(A), (A-B-A)n, (A-B-A)nX, (A-B)nX, A-D-B, A-B-D, A-D-B-D-A, A-B-D-B-A, (A-D-B)nA, (A-B-D)nA (A-D-B)nX, (B-D-B)nX, (A-B-D)nX or mixtures thereof, wherein
n is an integer from 0 to 30,
X is a coupling agent residue,
each A and D block is a polymer block resistant to sulfonation,
each B block is susceptible to sulfonation,
the A block is selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof;
the B block is a vinyl aromatic monomer,
the D block is a hydrogenated polymer or copolymer of a conjugated diene selected from isoprene, 1,3-butadiene and mixtures thereof;
wherein the block B is selectively sulfonated to contain from 10-100 mol % sulfonic acid or sulfonate salt functional groups based on the number of monomer units for the antimicrobial layer to kill at least 99% of microbes within 30 minutes of contact.

20. The method of claim 15, wherein the sulfonated polymer layer has a surface pH of <3.0.
